(19) United States
(12) Patent Application Publication
(10) Pub. No.: US 2026/0342363 A1
(43) Pub. Date: Oct. 29, 2026

(54) RADIO FREQUENCY MODULE AND COMMUNICATION DEVICE

(71) Applicant: Murata Manufacturing Co., Ltd., Nagaokakyo-shi (JP)

(72) Inventor: Kenji TAHARA, Nagaokakyo-shi (JP)

(21) Appl. No.: 19/636,324

(22) Filed: Apr. 1, 2026

(30) Foreign Application Priority Data
Apr. 23, 2025 (JP) 2025-071462

(51) Int. Cl. H04B 1/00; H04B 1/04

(52) U.S. Cl. CPC H04B 1/006; H04B 1/0483; H04B 2001/0408

(57) ABSTRACT

A radio frequency module includes a first output terminal and a second output terminal, a first balun including a main line connected between the first output terminal and the second output terminal, a first sub-line coupled to the main line, and a second sub-line coupled to the main line, a first amplifier having an output end connected to the first sub-line, a second amplifier having an output end connected to the second sub-line, a third amplifier, a fourth amplifier, a first line connected between an output end of the third amplifier and the first output terminal, a second line connected between an output end of the fourth amplifier and the second output terminal, a first switch connected between the output end of the third amplifier and a ground, and a second switch connected between the output end of the fourth amplifier and the ground.

### CROSS REFERENCE TO RELATED APPLICATION

This application claims priority from Japanese Patent Application No. 2025-071462, filed on April 23, 2025. The content of this application is incorporated herein by reference in its entirety.

### BACKGROUND OF THE DISCLOSURE

### 1. FIELD OF THE DISCLOSURE

The present disclosure generally relates to a radio frequency module and a communication device including the same and, more particularly, to a technique for switching between signal transmission paths while reducing the occurrence of a switching loss in the radio frequency module.

### 2. DESCRIPTION OF THE RELATED ART

In electronic apparatuses capable of transmitting and receiving radio frequency (RF) waves, amplifiers are known to be used for signal amplification. Japanese Unexamined Patent Application Publication No. 2018-137566 discloses a radio frequency module using a Doherty amplifier that does not include a choke coil or a bypass capacitor.

In the radio frequency module including the amplifier as disclosed in Japanese Unexamined Patent Application Publication No. 2018-137566, a switch may be used to switch signal transmission paths. However, when a switch is provided on a signal transmission path, a switching loss occurs during signal transmission.

The present disclosure has been made to solve such a problem, and it is a possible benefit of the present disclosure to switch between signal transmission paths while reducing the occurrence of a switching loss in a radio frequency module that transmits radio frequency signals using an antenna.

### BRIEF SUMMARY OF THE DISCLOSURE

A radio frequency module according to the present disclosure includes a first output terminal and a second output terminal, a first balun including a main line connected between the first output terminal and the second output terminal, a first sub-line coupled to the main line, and a second sub-line coupled to the main line, a first amplifier having an output end connected to the first sub-line, a second amplifier having an output end connected to the second sub-line, a third amplifier, a fourth amplifier, a first line connected between an output end of the third amplifier and the first output terminal, a second line connected between an output end of the fourth amplifier and the second output terminal, a first switch connected between the output end of the third amplifier and a ground, and a second switch connected between the output end of the fourth amplifier and the ground.

According to the present disclosure, in a radio frequency module, the path of a transmission signal outputted from a balun can be changed by controlling the conductive state of a switch that is not disposed on the transmission signal path. Accordingly, it is possible to change the transmission signal path without disposing a switch on the signal path. Therefore, in the radio frequency module that transmits radio frequency signals using an antenna, it is possible to switch between signal transmission paths while reducing the occurrence of a switching loss.

### BRIEF DESCRIPTION OF THE SEVERAL VIEWS OF THE DRAWINGS

FIG. 1 is a schematic diagram of a communication device according to a first embodiment;

FIG. 2 is a circuit diagram illustrating the detailed configuration of a power amplifier according to the first embodiment;

FIG. 3 is a diagram illustrating the transmission path of a transmission signal when radio waves are outputted from an antenna 30A;

FIG. 4 is a diagram illustrating the transmission path of a transmission signal when radio waves are outputted from an antenna 30B;

FIG. 5 is a flowchart illustrating a process performed by a signal processing circuit in the first embodiment;

FIG. 6 is a schematic diagram of a communication device according to a second embodiment;

FIG. 7 is a diagram illustrating the transmission path of a transmission signal in an amplification circuit when radio waves are transmitted in a first direction;

FIG. 8 is a diagram illustrating phase conversion performed by a hybrid when radio waves are transmitted in the first direction;

FIG. 9 is a diagram illustrating the transmission path of a transmission signal in the amplification circuit when radio waves are transmitted in a second direction;

FIG. 10 is a diagram illustrating phase conversion performed by a hybrid when radio waves are transmitted in the second direction;

FIG. 11 is a flowchart illustrating a process performed by the signal processing circuit in the second embodiment; and

FIG. 12 is a schematic diagram of a communication device according to a modification.

### DETAILED DESCRIPTION OF THE DISCLOSURE

Embodiments of the present disclosure will be described in detail below with reference to the drawings. The same reference numeral is used to represent the same part or the corresponding part in the drawings, and the description thereof will not be repeated.

### First Embodiment

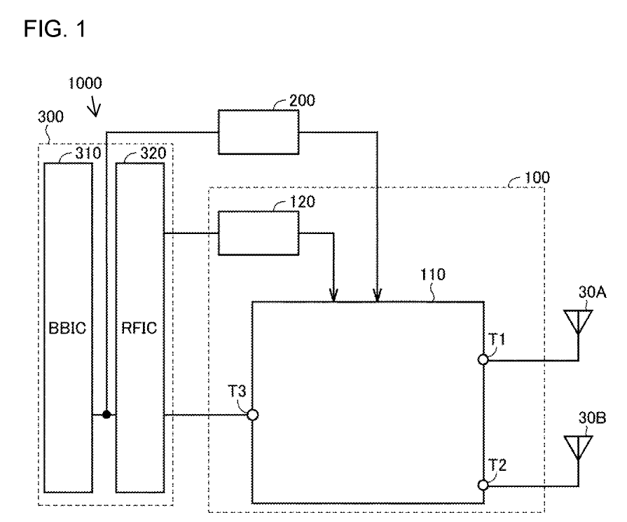

The schematic configuration of a radio frequency module 100 and a communication device 1000 according to a first embodiment will be described with reference to FIG. 1. FIG. 1 is a schematic diagram of the communication device 1000 according to the first embodiment.

### Overall Configuration

The circuit configuration of the communication device 1000 will be described below. The communication device 1000 is a device used in a communication system and is, for example, a mobile terminal, such as a smartphone or a tablet, a personal computer having a communication function, or a base station. As illustrated in FIG. 1, the communication device 1000 according to the first embodiment includes the radio frequency module 100, a power supply circuit 200, a signal processing circuit 300, and antennas 30A and 30B.

The radio frequency module 100 is connected to the antennas 30A and 30B for transmitting and receiving radio waves. The signal processing circuit 300 includes a baseband integrated circuit (BBIC) 310 forming a baseband signal processing circuit, and a radio frequency integrated circuit (RFIC) 320.

The radio frequency module 100 includes a control circuit 120 and a power amplifier 110. The radio frequency module 100 transmits radio frequency (RF) signals between the RFIC 320 and the antennas 30A and 30B. The RFIC 320 processes radio frequency signals to be transmitted to or received from the power amplifier 110.

The RFIC 320 up-converts an intermediate frequency (IF) signal inputted from the BBIC 310 into a radio frequency signal (transmission signal) and outputs the generated radio frequency signal to a terminal T3 of the power amplifier 110. The power amplifier 110 amplifies the transmission signal transmitted from the RFIC 320 and outputs the amplified transmission signal to at least one of the antennas 30A and 30B via the terminal T3.

The communication device 1000 is a dual-band communication device having the antennas 30A and 30B. The antennas 30A and 30B transmit transmission signals inputted to the terminal T3 as radio waves. In the communication device 1000 according to the first embodiment, a transmission frequency band outputted from the antenna 30A is, for example, the band from 122.25 GHz to 148.5 GHz, and a transmission frequency band outputted from the antenna 30B is, for example, the band from 151.5 GHz to 174.8 GHz.

Hereinafter, the transmission frequency band outputted from the antenna 30A may be referred to as a "first frequency band," and the transmission frequency band outputted from the antenna 30B may be referred to as a "second frequency band." In the first embodiment, the first frequency band is lower than the second frequency band. In some aspects, the transmission bands of the communication device 1000 may be other bands. For example, the transmission frequency band outputted from the antenna 30A may be the band from 130 GHz to 140 GHz, and the transmission frequency band outputted from the antenna 30B may be the band from 160 GHz to 170 GHz.

The power supply circuit 200 generates a power supply voltage on the basis of transmission information from the BBIC 310. The generated power supply voltage is supplied to, for example, switches and amplifiers included in the power amplifier 110, which will be described below. The control circuit 120 controls the switches and the amplifiers included in the power amplifier 110, which will be described below, on the basis of a control signal outputted from the RFIC 320. Some or all of the functions of the control circuit 120 may be implemented in the signal processing circuit 300.

### Circuit Configuration

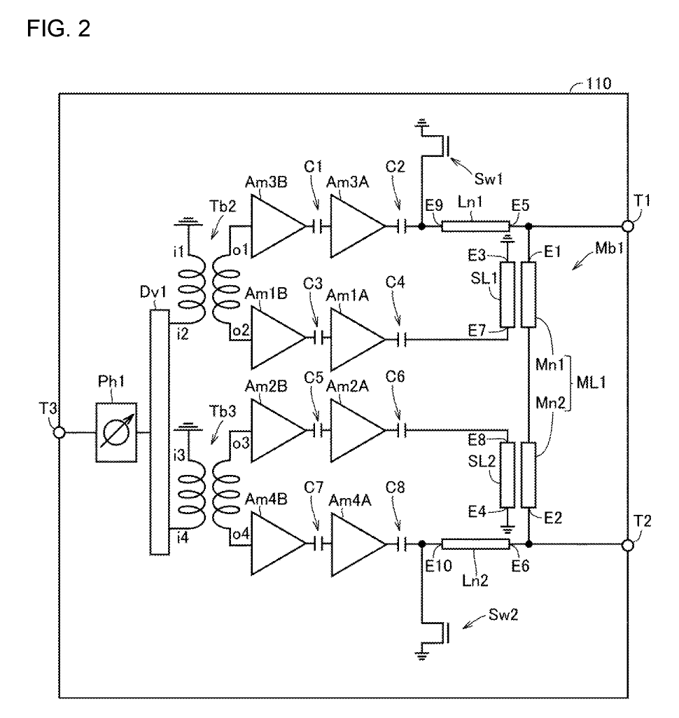

FIG. 2 is a circuit diagram illustrating the detailed configuration of the power amplifier 110 according to the first embodiment. Referring to FIG. 2, the power amplifier 110 includes the terminals T1 to T3, a phase shifter Ph1, a divider Dv1, transformers Tb2 and Tb3, amplifiers Am1A to Am4A and Am1B to Am4B, capacitors C1 to C8, a balun Mb1, switches Sw1 and Sw2, and lines Ln1 and Ln2. Hereinafter, the transformers Tb2 and Tb3 may be collectively referred to as a "transformer Tb," and the amplifiers Am1A to Am4A and Am1B to Am4B may be collectively referred to as an "amplifier Am." In the present embodiment, the transformer Tb functions as a balun.

Configurations included in the power amplifier 110 (the phase shifter Ph1, the divider Dv1, the transformer Tb, the amplifier Am, the lines Ln1 and Ln2, and the balun Mb1) will be described below along a path through which a transmission signal is transmitted in the power amplifier 110. A transmission signal outputted from the RFIC 320 to the power amplifier 110 is inputted to the phase shifter Ph1 via the terminal T3. The phase shifter Ph1 is configured to be capable of adjusting the phase of a transmission signal inputted from the terminal T3. The phase shifter Ph1 advances an input signal from the RFIC 30 by a predetermined phase shift amount θ and outputs the phase-shifted signal to the divider Dv1. In the present embodiment, the phase shift amount θ that can be set in the phase shifter Ph1 is greater than or equal to 0° and less than or equal to 90°.

The transmission signal whose phase has been adjusted by the phase shifter Ph1 is divided into two signals by the divider Dv1. The signals pass through corresponding signal paths and are inputted to corresponding ends of the primary windings of the transformers Tb2 and Tb3. Specifically, one of the transmission signals provided by the division by the divider Dv1 is inputted to an end portion i2 of the transformer Tb2, and the other one of them is inputted to an end portion i4 of the transformer Tb3. As illustrated in FIG. 2, an end portion i1 of the primary winding of the transformer Tb2 and an end portion i3 of the primary winding of the transformer Tb3 are connected to a ground potential.

Each of the transformers Tb2 and Tb3 converts the transmission signal inputted from the divider Dv1 into two signals of opposite phases. Specifically, the transformer Tb2 converts the transmission signal inputted to the end portion i2 into a transmission signal to be inputted to the amplifier Am3B via an end portion o1 of a secondary winding and a transmission signal to be inputted to the amplifier Am1B via an end portion o2 of the secondary winding. The transmission signals inputted to the amplifiers Am1B and Am3B are differential signals.

The transformer Tb3 converts the transmission signal inputted to the end portion i4 into a transmission signal to be inputted to the amplifier Am2B via an end portion o3 of a secondary winding and a transmission signal to be inputted to the amplifier Am4B via an end portion o4 of the secondary winding. The transmission signals inputted to the amplifiers Am2B and Am4B are differential signals. Since the transmission signals inputted to the end portions i2 and i4 are signals provided by the division by the same divider Dv1, the transmission signals inputted to the amplifiers Am1B and Am2B also have an opposite-phase relationship. That is, the transmission signals inputted to the amplifiers Am1B and Am2B are also differential signals.

The amplifiers Am1B to Am4B are driver-stage amplifiers, and the amplifiers Am1A to Am4A are output-stage amplifiers. As illustrated in FIG. 2, capacitors C3, C5, C1, and C7 are connected between the amplifiers Am1B to Am4B and the amplifiers Am1A to Am4A, respectively. The amplifier Am amplifies a transmission signal inputted thereto. Although a single amplifier is illustrated as a driver-stage amplifier in FIG. 2, each of the amplifiers Am1B to Am4B may include a plurality of amplifiers. Similarly, each of the output-stage amplifiers Am1A to Am4A may include a plurality of amplifiers. The driver stage and the output stage may be configured as a single amplifier.

The amplifier Am3A is connected to an end portion E9 of the line Ln1 via the capacitor C2. The end portion E9 is further connected to the ground potential via the switch Sw1. When the switch Sw1 is brought into a conductive state, a shunt line is formed. The amplifier Am4A is connected to an end portion E10 of the line Ln2 via the capacitor C8. The end portion E10 is further connected to the ground potential via the switch Sw2. When the switch Sw2 is brought into a conductive state, a shunt line is formed.

Each of the lines Ln1 and Ln2 has an electrical length of approximately λ/4, where λ is the wavelength of a radio frequency signal to be transmitted therethrough. That is, each of the lines Ln1 and Ln2 has a line length of approximately one-quarter of the wavelength of a radio frequency signal to be transmitted therethrough. In the first embodiment, for example, a center frequency between the lower-limit frequency of the first frequency band and the upper-limit frequency of the second frequency band is defined as λ.

An end portion E5 of the line Ln1 is connected to the terminal T1, and an end portion E6 of the line Ln2 is connected to the terminal T2. The end portion E5 is further connected to an end portion E1 of a line Mn1 that is part of the balun Mb1, and the end portion E6 is further connected to an end portion E2 of a line Mn2 that is part of the balun Mb1.

The balun Mb1 is a so-called merchant balun and includes a pair of balanced lines SL1 and SL2 and an unbalanced main line ML1. The main line ML1 has a configuration in which the lines Mn1 and Mn2 are connected to each other.

As will be described below, the balun Mb1 functions as a merchant balun by controlling the switches Sw1 and Sw2 such that impedance states seen from the end portions E1 and E2 toward the lines Ln1 and Ln2, respectively, are controlled. Lengths of the main line ML1 and the lines SL1 and SL2 are appropriately set in accordance with the above-described λ. Specifically, each of the lines SL1, SL2, Mn1, and Mn2 has an electrical length of approximately λ/4. That is, the main line ML1 has an electrical length of approximately λ/2.

An end portion E7 of the line SL1 that is part of the balun Mb1 is connected to the output terminal of the amplifier Am1A via the capacitor C4. An end portion E8 of the line SL2 that is part of the balun Mb1 is connected to the output terminal of the amplifier Am2A via the capacitor C6. An end portion E3 of the line SL1 and an end portion E4 of the line SL2 are connected to the ground potential.

As described above, the transmission signal inputted to the end portion o2 of the transformer Tb2 and the transmission signal inputted to the end portion o3 of the transformer Tb3 are differential signals. Accordingly, the transmission signal that is amplified by the amplifiers Am1B and Am1A and is inputted to the end portion E7 of the line SL1 and the transmission signal that is amplified by the amplifiers Am2B and Am2A and is inputted to the end portion E8 of the line SL2 are also differential signals. The balun Mb1 converts the differential signals (balanced signals) inputted to the end portion E7 of the balanced line SL1 and the end portion E8 of the balanced line SL2 into an unbalanced signal, and outputs the unbalanced signal to the main line Mn1.

The balanced line SL1 is arranged alongside the line Mn1 of the unbalanced main line ML1, and the lines SL1 and Mn1 are coupled lines. Similarly, the balanced line SL2 is arranged alongside the line Mn2 of the unbalanced main line ML1, and the lines SL2 and Mn2 are coupled lines. When the balun Mb1 functions, the propagation direction of a signal in one of these couplings becomes opposite, and a phase of the signal is inverted. By the coupling between the lines SL1 and Mn1, the coupling between the lines SL2 and Mn2, and the phase inversion of the transmission signal in one of the couplings, the respective transmission signals outputted to the main line ML1 become in phase with each other. The end portion E1 of the line Mn1 included in the main line ML1 is connected to the terminal T1. The end portion E2 of the line Mn2 included in the main line ML1 is connected to the terminal T2.

In the first embodiment, when radio waves are outputted from the antenna 30A connected to the terminal T1, a transmission signal in the first frequency band is inputted to the terminal T3, the switch Sw1 is controlled to be in a non-conductive state, the switch Sw2 is controlled to be in a conductive state, and no power is supplied to the amplifiers Am4A and Am4B. On the other hand, when radio waves are outputted from the antenna 30B connected to the terminal T2, a transmission signal in the second frequency band is inputted to the terminal T3, the switch Sw1 is controlled to be in a conductive state, the switch Sw2 is controlled to be in a non-conductive state, and no power is supplied to the amplifiers Am3A and Am3B.

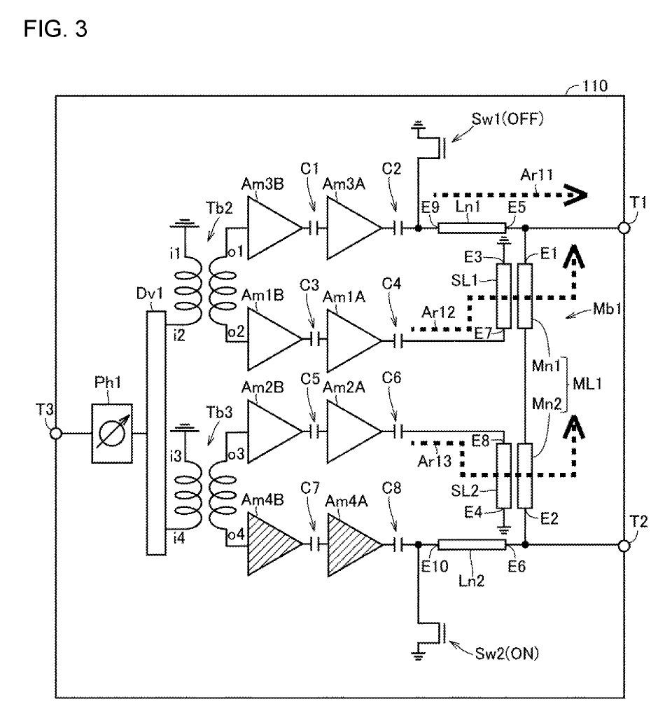

FIG. 3 is a diagram illustrating the transmission path of a transmission signal when radio waves are outputted from the antenna 30A. The transmission line Ln2 having an electrical length of λ/4 is connected in series between the end portion E2 of the line Mn2 and a ground potential. An inductive component of the line Ln2 rotates an impedance by 180 degrees clockwise on a Smith chart. Accordingly, when the switch Sw2 connected to the ground potential is controlled to be in a conductive state, the line Ln2 causes an impedance seen from the end portion E2 toward the line Ln2 and the terminal T2 side to be in an open state. That is, the transmission of a transmission signal from the end portion E2 toward the line Ln2 and the terminal T2 side is suppressed.

As a result, in the example illustrated in FIG. 3, the balun Mb1 functions as a merchant balun that transmits in-phase transmission signals from the end portion E1 to the terminal T1. Specifically, as illustrated in FIG. 3, a transmission signal outputted from the amplifier Am2A is transmitted to the terminal T1 as indicated by a dashed arrow Ar13. Similarly, a transmission signal outputted from the amplifier Am1A is transmitted to the terminal T1 as indicated by a dashed arrow Ar12. At this time, the signal transmitted to the line Mn2 undergoes phase inversion as a result of reversal of its propagation direction and thus becomes in phase with the signal transmitted to the line Mn1. As illustrated in FIG. 3, since the switch Sw1 is in a non-conductive state, a transmission signal outputted from the amplifier Am3A is transmitted to the terminal T1 as indicated by a dashed arrow Ar11. As illustrated in FIG. 3, by controlling the conductive states of the switches Sw1 and Sw2, a transmission signal in the first frequency band can be outputted to the antenna 30A via the terminal T1.

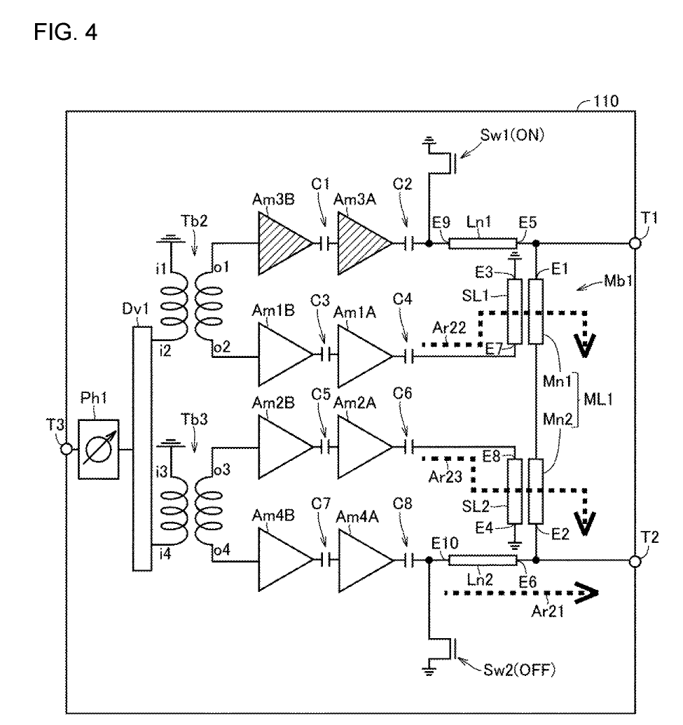

FIG. 4 is a diagram illustrating the transmission path of a transmission signal when radio waves are outputted from the antenna 30B. The transmission line Ln1 having an electrical length of λ/4 is connected in series between the end portion E1 of the line Mn1 and the ground potential. An inductive component of the line Ln1 rotates an impedance by 180 degrees clockwise on a Smith chart. Accordingly, when the switch Sw1 connected to the ground potential is controlled to be in a conductive state, the line Ln1 causes an impedance seen from the end portion E1 toward the line Ln1 and the terminal T1 side to be in an open state. That is, the transmission of a transmission signal from the end portion E1 toward the line Ln1 and the terminal T1 side is suppressed.

As a result, in the example illustrated in FIG. 4, the balun Mb1 functions as a merchant balun that transmits in-phase transmission signals from the end portion E2 to the terminal T2. Specifically, as illustrated in FIG. 4, a transmission signal outputted from the amplifier Am1A is transmitted to the terminal T2 as indicated by a dashed arrow Ar22. Similarly, a transmission signal outputted from the amplifier Am2A is transmitted to the terminal T2 as indicated by a dashed arrow Ar23. At this time, the signal transmitted to the line Mn1 undergoes phase inversion as a result of reversal of its propagation direction and thus becomes in phase with the signal transmitted to the line Mn2. As illustrated in FIG. 4, since the switch Sw2 is in a non-conductive state, a transmission signal outputted from the amplifier Am4A is transmitted to the terminal T2 as indicated by a dashed arrow Ar21. As illustrated in FIG. 4, by controlling the conductive states of the switches Sw1 and Sw2, a transmission signal in the second frequency band can be outputted to the antenna 30B via the terminal T2.

Thus, the radio frequency module 100 according to the first embodiment can change the path of a transmission signal outputted from the balun Mb1 by controlling the conductive states of the switches Sw1 and Sw2 that are not disposed on a transmission signal path. When a signal path is changed using a switch disposed on a transmission signal path, a switching loss occurs at the switch disposed on the transmission signal path during signal transmission. In comparison with an example in which a switch is disposed on a transmission signal path, the radio frequency module 100 according to the first embodiment enables the switching of a signal transmission path while reducing the occurrence of a switching loss. In particular, in the first embodiment, it is possible to change the frequency band of a transmission signal while reducing the occurrence of a switching loss.

### Processing in Signal Processing Circuit

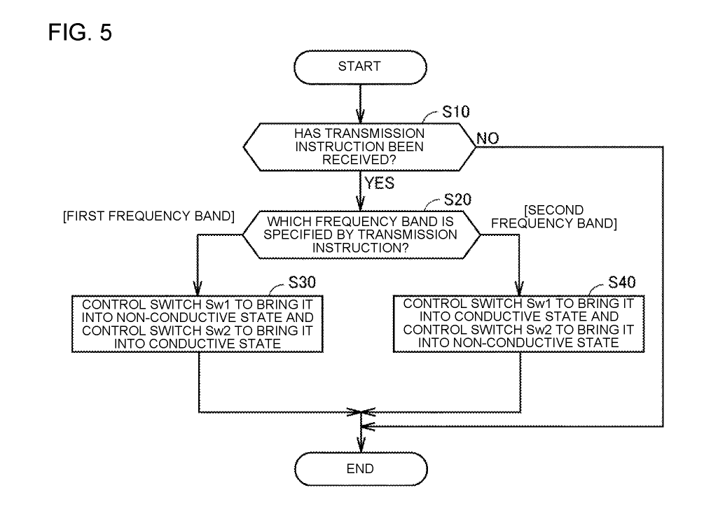

FIG. 5 is a flowchart illustrating a process performed by the signal processing circuit 300 in the first embodiment. The flowchart illustrated in FIG. 5 is implemented by being executed by a control unit included in the signal processing circuit 300 included in the communication device 1000.

The control unit in the signal processing circuit 300 determines whether the control unit has received an instruction to transmit a transmission signal (step S10). When the control unit in the signal processing circuit 300 has not received the instruction to transmit a transmission signal (NO in step S10), the control unit ends the process.

When the control unit in the signal processing circuit 300 has received the instruction to transmit a transmission signal (YES in step S10), the control unit determines whether a frequency band specified by the transmission instruction is the first frequency band or the second frequency band (step S20). When the specified frequency band is the first frequency band, the control unit in the signal processing circuit 300 controls the switch Sw1 to bring it into a non-conductive state and controls the switch Sw2 to bring it into a conductive state (step S30) and then ends the process. When the specified frequency band is the second frequency band, the control unit in the signal processing circuit 300 controls the switch Sw1 to bring it into a conductive state and controls the switch Sw2 to bring it into a non-conductive state (step S40) and then ends the process.

The terminals T1 and T2 may correspond to a "first output terminal" and a "second output terminal," respectively, in the present disclosure. The terminal T3 may correspond to an "input terminal" in the present disclosure. The lines SL1 and SL2 may correspond to a "first sub-line" and a "second sub-line," respectively, in the present disclosure. The lines Ln1 and Ln2 may correspond to a "first line" and a "second line," respectively, in the present disclosure. The amplifiers Am1A and Am1B may correspond to a "first amplifier" in the present disclosure. The amplifiers Am2A and Am2B may correspond to a "second amplifier" in the present disclosure. The amplifiers Am3A and Am3B may correspond to a "third amplifier" in the present disclosure. The amplifiers Am4A and Am4B may correspond to a "fourth amplifier" in the present disclosure. The switches Sw1 and Sw2 may correspond to a "first switch" and a "second switch," respectively, in the present disclosure.

### Second Embodiment

In the first embodiment, the configuration has been described in which the function of a dual-band antenna is implemented by controlling the conductive states of the switches Sw1 and Sw2. In a second embodiment, a configuration will be described in which the directivity of a transmission signal can be changed by controlling the conductive states of the switches Sw1 and Sw2. In the second embodiment, descriptions of configurations common to the first embodiment will not be repeated.

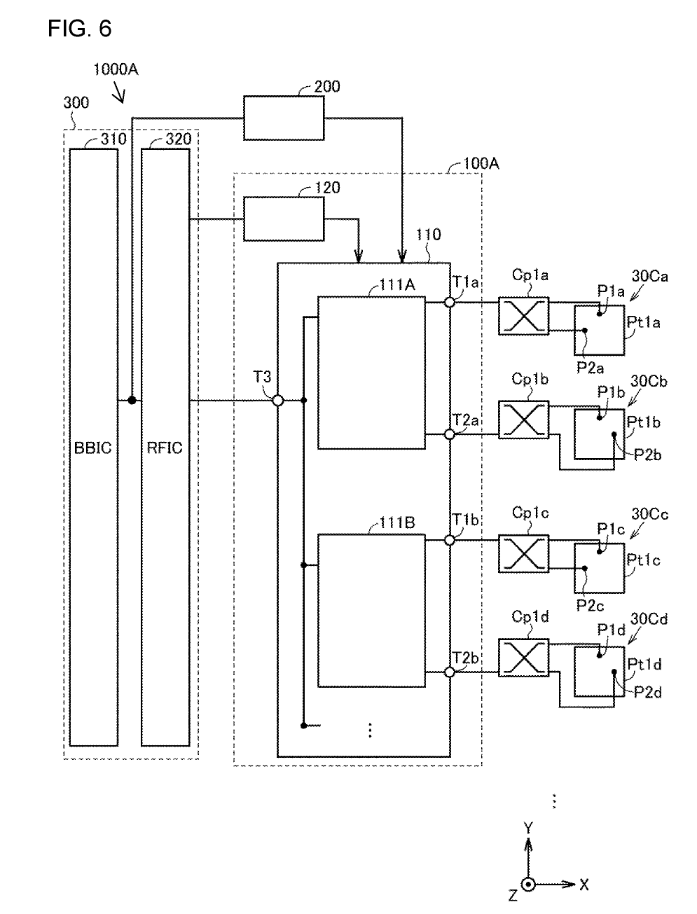

The schematic configuration of a radio frequency module 100A and a communication device 1000A according to the second embodiment will be described with reference to FIG. 6. FIG. 6 is a schematic diagram of the communication device 1000A according to the second embodiment.

In the second embodiment, the power amplifier 110 includes a plurality of amplification circuits 111A and 111B. The amplification circuit 111A is connected to an antenna 30Ca for transmitting and receiving radio waves via a hybrid coupler Cp1a and an antenna 30Cb for transmitting and receiving radio waves via a hybrid coupler Cp1b. The amplification circuit 111B is connected to an antenna 30Cc for transmitting and receiving radio waves via a hybrid coupler Cp1c and an antenna 30Cd for transmitting and receiving radio waves via a hybrid coupler Cp1d. In the second embodiment, an array antenna capable of performing beamforming is configured by providing a predetermined phase difference between radio waves outputted from the amplification circuits 111A and 111B included in the radio frequency module 100A. That is, in the array antenna according to the second embodiment, by transmitting to adjacent antennas transmission signals between which a predetermined phase difference is provided, the directivity of radio waves radiated from the array antenna can be adjusted.

Hereinafter, the amplification circuits 111A and 111B may be collectively referred to as an "amplification circuit 111." The configuration of the amplification circuit 111 according to the second embodiment is the same as that of the power amplifier 110 described in the first embodiment. The number of amplification circuits 111 included in the power amplifier 110 is not limited to two and may be three or more. Each of the multiple amplification circuits 111 included in the power amplifier 110 has a similar structure. The radio frequency module 100A according to the second embodiment will be described below focusing on the amplification circuit 111A, the hybrid couplers Cp1a and Cp1b, and the antennas 30Ca and 30Cb.

The hybrid coupler Cp1a has two input terminals and two output terminals. A terminal T1a is connected to one input terminal of the hybrid coupler Cp1a, and no terminal is connected to the other input terminal.

The antenna 30Ca is a patch antenna having a plate-shaped radiation electrode Pt1a. The shape of the radiation electrode Pt1a is not limited to the rectangular shape illustrated in FIG. 6 and may be circular, elliptical, or other polygonal shapes.

The hybrid coupler Cp1a receives the supply of a signal from the terminal T1a and outputs two transmission signals having a phase difference of 90° from the two output ends. That is, the hybrid coupler Cp1a supplies respective radio frequency signals from the two output ends to two feeding points P1a and P2a. The two feeding points P1a and P2a are arranged at positions that are point-symmetric with respect to the center of the radiation electrode Pt1a by 90 degrees. More specifically, the feeding point P1a is connected to one output terminal of the hybrid coupler Cp1a, and the feeding point P2a is connected to the other output terminal of the hybrid coupler Cp1a. In the following description, the normal direction of the radiation electrode Pt1a (the radiation direction of radio waves) is defined as a positive direction of a Z axis and a plane perpendicular to a Z-axis direction is defined as an X axis and a Y axis.

The feeding point P1a is offset from the center of the radiation electrode Pt1a in the positive direction of the Y axis. As a result, the radiation electrode Pt1a radiates radio waves polarized in the Y-axis direction toward a direction normal to the radiation electrode Pt1a. The feeding point P2a is offset from the center of the radiation electrode Pt1a in the negative direction of the X axis. The X-axis direction and the Y-axis direction are orthogonal to each other. As a result, the radiation electrode Pt1a radiates radio waves polarized in the X-axis direction toward the direction normal to the radiation electrode Pt1a. In the following description, for convenience, the polarization of radio waves radiated from the feeding point P1a may be referred to as "vertical polarization (V polarization)," and the polarization of radio waves radiated from the feeding point P2a may be referred to as "horizontal polarization (H polarization)."

By supplying radio frequency signals having a phase difference of 90° to the two feeding points P1a and P2a that are offset from the center of the radiation electrode Pt1a in the directions orthogonal to each other, the plate-shaped antenna 30Ca radiates circularly polarized radio waves. For example, when the phase of a signal supplied to the feeding point P2a is delayed relative to the phase of a signal supplied to the feeding point P1a, circularly polarized waves rotating rightward (clockwise) toward a radiation direction are radiated from the radiation electrode Pt1a. In contrast, when the phase of a signal supplied to the feeding point P1a is delayed relative to the phase of a signal supplied to the feeding point P2a, circularly polarized waves rotating leftward (counterclockwise) toward the radiation direction are radiated from the radiation electrode Pt1a.

The antenna 30Cb is also a patch antenna having a plate-shaped radiation electrode Pt1b. The hybrid coupler Cp1b receives the supply of a signal from a terminal T2a and outputs two transmission signals having a phase difference of 90° from two output ends. That is, the hybrid coupler Cp1b supplies respective radio frequency signals from the two output ends to two feeding points P1b and P2b.

The feeding point P1b is offset from the center of the radiation electrode Pt1b in the positive direction of the Y axis like in the radiation electrode Pt1a. On the other hand, the feeding point P2a is offset from the center of the radiation electrode Pt1b in the positive direction of the X axis unlike in the radiation electrode Pt1a. As a result, in the radio frequency module 100A, it is possible to output radio waves having the same rotational direction regardless of whether the antenna 30Ca or 30Cb is used.

In the communication device 1000A according to the second embodiment, the phases of radio waves in a V polarization direction and an H polarization direction of the antenna 30C are appropriately adjusted to adjust a predetermined phase difference between the phases of adjacent patch antennas. In a typical radio frequency module, for example, when the phase of radio waves in the V polarization direction is adjusted within the range of 0° to 180°, a phase shifter may be provided that is capable of adjusting the phase of a signal processed in the typical radio frequency module within the range of 0° to 180°. That is, a phase shifter is provided that is capable of adjusting a phase within the same range (0° to 180°) as the range of a phase of radio waves in the V polarization direction that needs to be adjusted. However, when a phase shifter having a large adjustable phase range is provided, there has been a case where the size of a radio frequency module increases.

Accordingly, by controlling the conductive states of the switches Sw1 and Sw2, the radio frequency module 100A according to the second embodiment can, using the phase shifter Ph1 capable of adjusting the phase shift amount θ only within the range of 0° to 90° that is smaller than the range of 0° to 180°, adjust the phase of radio waves in the V polarization direction in the antennas 30Ca and 30Cb within the range of 0° to 180° that is larger than the adjustable range of the phase shifter Ph1 and adjust the phase of radio waves in the H polarization direction in the antenna 30Ca within the range of -180° to 0°.

Upon receiving an instruction to output circularly polarized radio waves at a predetermined steering angle of an array antenna, the signal processing circuit 300 according to the second embodiment controls the conductive states of the switches Sw1 and Sw2 in response to the instruction. The amplification circuit 111A according to the second embodiment is disposed to output a radio wave in the V polarization direction having a phase within the range of 0° to 90° and a radio wave in the H polarization direction having a phase within the range of -90° to 0° when radio waves are transmitted toward a first direction that is the steering angle of an array antenna. The amplification circuit 111A is also disposed to output a radio wave in the V polarization direction having a phase within the range of 90° to 180° and a radio wave in the H polarization direction having a phase within the range of -180° to -90° when radio waves are transmitted toward a second direction that is the steering angle of the array antenna different from the first direction.

When the phase of a radio wave in the V polarization direction is adjusted within the range of 0° to 90° and the phase of a radio wave in the H polarization direction is adjusted within the range of -90° to 0°, the switch Sw1 is controlled to be in a non-conductive state, the switch Sw2 is controlled to be in a conductive state, and no power is supplied to the amplifiers Am4A and Am4B. On the other hand, when the phase of a radio wave in the V polarization direction is adjusted within the range of 90° to 180° and the phase of a radio wave in the H polarization direction is adjusted within the range of -180° to -90°, the switch Sw1 is controlled to be in a conductive state, the switch Sw2 is controlled to be in a non-conductive state, and no power is supplied to the amplifiers Am3A and Am3B.

The range of 0° to 90° may mean the range of greater than or equal to 0° and less than or equal to 90°, the range of greater than 0° and less than or equal to 90°, the range of greater than or equal to 0° and less than 90°, or the range of greater than 0° and less than 90°. Whether to include the thresholds within the range may be determined as appropriate for each embodiment.

The configurations of the amplification circuit 111B, terminals T1b and T2b, hybrid couplers Cp1c and Cp1d, and antennas 30Cc and 30Cd illustrated in FIG. 6 correspond to the configurations of the amplification circuit 111A, the terminals T1a and T2a, the hybrid couplers Cp1a and Cp1b, and the antennas 30Cc and 30Cd, respectively. The terminals T1a and T2a according to the second embodiment may correspond to the "first output terminal" and the "second output terminal," respectively, in the present disclosure. Similarly, the terminals T1b and T2b may correspond to the "first output terminal" and the "second output terminal," respectively, in the present disclosure. The hybrid couplers Cp1a, Cp1b, Cp1c, and Cp1d according to the second embodiment may correspond to a "first hybrid coupler," a "second hybrid coupler," a "third hybrid coupler," and a "fourth hybrid coupler," respectively, in the present disclosure. The antennas 30Ca, 30Cb, 30Cc, and 30Cd according to the second embodiment may correspond to a "third antenna," a "fourth antenna," a "fifth antenna," and a "sixth antenna," respectively, in the present disclosure.

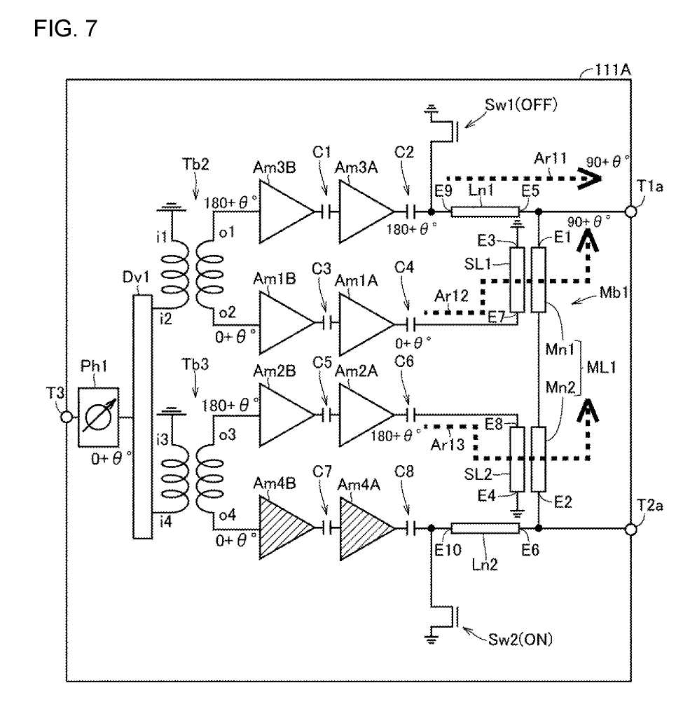

FIG. 7 is a diagram illustrating the transmission path of a transmission signal in the amplification circuit 111A when radio waves are transmitted in the first direction. As illustrated in FIG. 7, the switch Sw1 is controlled to be in a non-conductive state, and the switch Sw2 is controlled to be in a conductive state. In this case, a transmission signal is outputted from the terminal T1 as described with reference to FIG. 3.

FIG. 7 illustrates the phases of transmission signals at respective time points in the radio frequency module 100A. Since an adjustable range of the phase shift amount θ is the range of 0° to 90°, the phase of a transmission signal after phase adjustment by the phase shifter Ph1 is 0 + θ°.

The divider Dv1 receives, from the phase shifter Ph1, a transmission signal having a phase of 0 + θ°, and inputs the transmission signal to each of the end portions i2 and i4. The transmission signal divided by the divider Dv1 is further divided by each of the transformers Tb2 and Tb3 into two transmission signals having phases of 180 + θ° and 0 + θ°. Specifically, as illustrated in FIG. 7, the respective transmission signals having a phase of 180 + θ° are inputted to the end portions o1 and o3 by the transformers Tb2 and Tb3. The respective transmission signals having a phase of 0 + θ° are inputted to the end portions o2 and o4 by the transformers Tb2 and Tb3.

The transmission signals outputted to the end portions o1, o2, and o3 are amplified by corresponding amplifiers. The transmission signal outputted from the amplifier Am3A has a phase of 180 + θ°. As described above, since the line Ln1 has a line length of approximately one-quarter wavelength, the phase of a radio frequency signal outputted from the amplifier Am3A is delayed by approximately 90° when the signal passes through the line Ln1. That is, as indicated by an arrow Ar11 in FIG. 7, the phase of the transmission signal outputted from the amplifier Am3A becomes 90 + θ° and is outputted to the terminal T1a.

The transmission signal outputted from the amplifier Am1A has a phase of 0 + θ°. As indicated by an arrow Ar12, the phase of the transmission signal outputted from the amplifier Am1A becomes 90 + θ° by being transmitted from the line SL1 to the line Mn1 and is outputted to the terminal T1a. The transmission signal outputted from the amplifier Am2A has a phase of 180 + θ°. As indicated by an arrow Ar13, the transmission signal outputted from the amplifier Am2A is phase-inverted by a reversal of its propagation direction and becomes in phase with the signal transmitted to the line Mn1. That is, the phase of the transmission signal outputted from the amplifier Am2A also becomes 90 + θ° and is outputted to the terminal T1a.

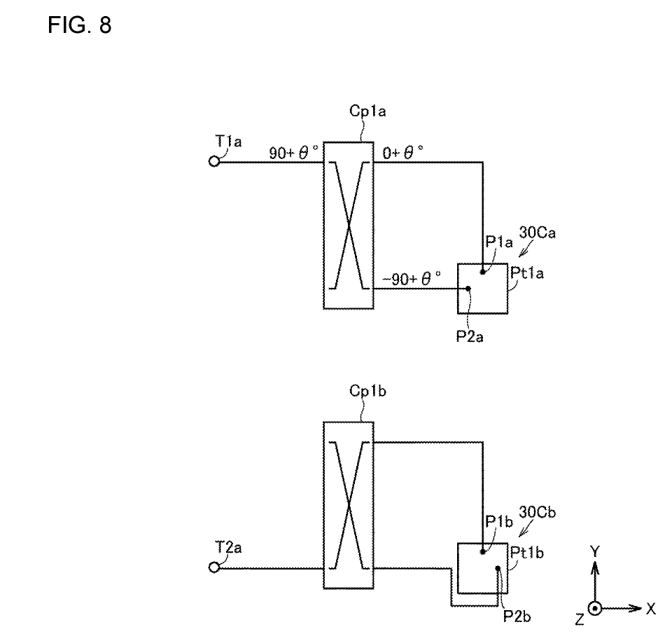

FIG. 8 is a diagram illustrating phase conversion performed by the hybrid coupler Cp1a when radio waves are transmitted in the first direction. As described with reference to FIG. 7, the transmission signal having a phase of 90 + θ° is outputted from the terminal T1a to the hybrid coupler Cp1a. Since the switch Sw2 is in a conductive state as illustrated in FIG. 7, the terminal T2a is grounded in the state illustrated in FIGS. 7 and 8.

When the transmission signal is supplied from the terminal T1a, the hybrid coupler Cp1a according to the second embodiment supplies, to the feeding point P1a, a signal having a phase delayed by 90° from the phase of the transmission signal supplied from the terminal T1a. That is, the transmission signal having a phase of 0 + θ° is supplied to the feeding point P1a. In other words, in the example illustrated in FIGS. 7 and 8, by adjusting the phase shift amount θ, the phase of radio waves in the V polarization direction can be adjusted within the range of 0° to 90°.

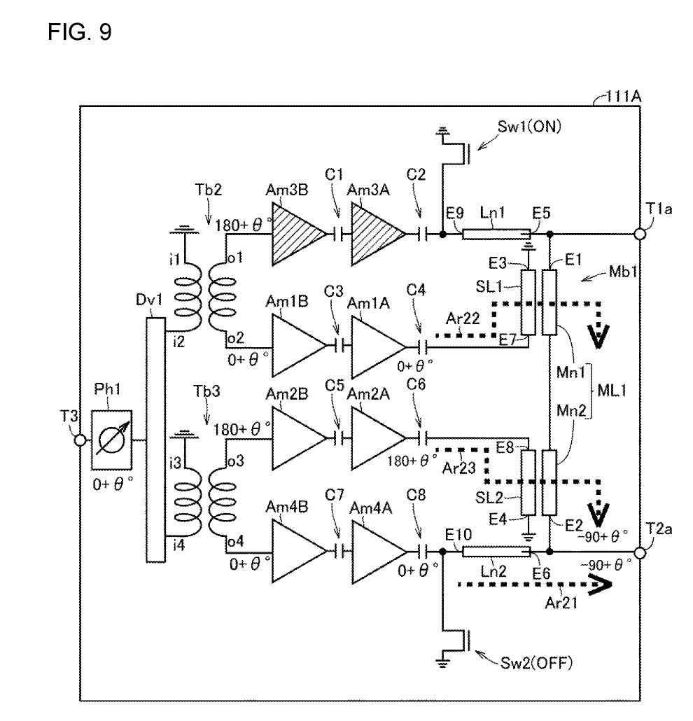

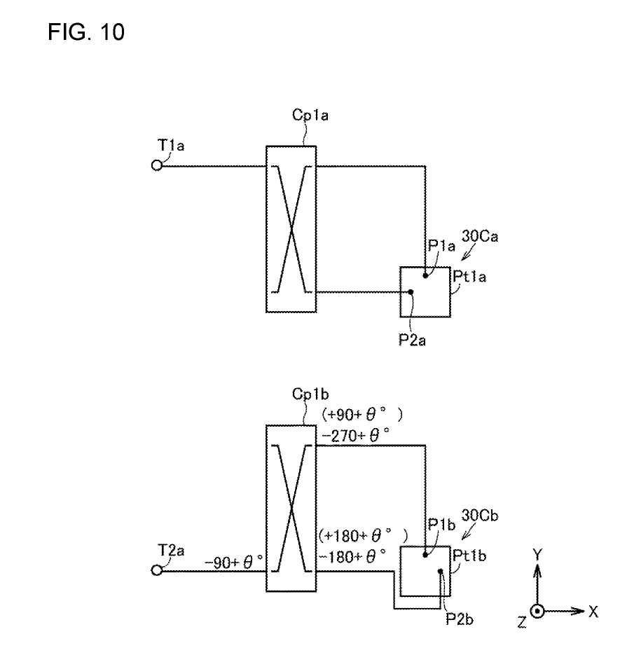

When the transmission signal is supplied from the terminal T1a, the hybrid coupler Cp1a supplies, to the feeding point P2a, a signal having a phase delayed by 180° from the phase of the transmission signal supplied from the terminal T1a. That is, the transmission signal having a phase of -90 + θ° is supplied to the feeding point P2a. In other words, in the example illustrated in FIGS. 7 and 8, by adjusting the phase shift amount θ, the phase of radio waves in the H polarization direction can be adjusted within the range of -90° to 0°. Since the phase of the signal supplied to the feeding point P1a is advanced relative to the phase of the signal supplied to the feeding point P2a, the radiation electrode Pt1a radiates circularly polarized radio waves rotating rightward (clockwise) toward the radiation direction. Thus, in the radio frequency module 100A according to the second embodiment, a phase is determined for each of the amplification circuits 111 in accordance with the steering angle of radio waves as an array antenna, and θ in the amplification circuit 111 is determined in accordance with the determined phase. FIGS. 7 and 8 illustrate the exemplary case where radio waves in the V polarization direction having phases within the range of 0° to 90° and radio waves in the H polarization direction having phases within the range of -90° to 0° are outputted. However, depending on the steering angle of radio waves as an array antenna, the output of circularly polarized radio waves having phases within a range different from the range of -90° to 0° described with reference to FIGS. 7 and 8 may be required. An example of such a radio wave output will be described with reference to FIGS. 9 and 10.

FIG. 9 is a diagram illustrating the transmission path of a transmission signal in the amplification circuit 111A when radio waves are transmitted in the second direction. As illustrated in FIG. 9, the switch Sw1 is controlled to be in a conductive state, and the switch Sw2 is controlled to be in a non-conductive state. In this case, a transmission signal is outputted from the terminal T2a as described with reference to FIG. 4.

The transmission signals outputted to the end portions o2, o3, and o4 are amplified by corresponding amplifiers. The transmission signal outputted from the amplifier Am4A has a phase of 0 + θ°. When a radio frequency signal passes through the line Ln2, the phase of the signal is delayed by approximately 90°. That is, as indicated by an arrow Ar21 in FIG. 9, the phase of the transmission signal outputted from the amplifier Am4A becomes -90 + θ° and is outputted to the terminal T2a.

The transmission signal outputted from the amplifier Am2A has a phase of 180 + θ°. As indicated by an arrow Ar23, the phase of the transmission signal outputted from the amplifier Am2A becomes -90 + θ° by being transmitted from the line SL2 to the line Mn2 and is outputted to the terminal T2a. The transmission signal outputted from the amplifier Am1A has a phase of 0 + θ°. As indicated by the arrow Ar22, the transmission signal outputted from the amplifier Am1A is phase-inverted by a reversal of its propagation direction and becomes in phase with the signal transmitted to the line Mn2. That is, the phase of the transmission signal outputted from the amplifier Am1A also becomes -90 + θ° and is outputted to the terminal T2a.

FIG. 10 is a diagram illustrating phase conversion performed by the hybrid coupler Cp1b when radio waves are transmitted in the second direction. As described with reference to FIG. 9, the transmission signal having a phase of -90 + θ° is outputted from the terminal T2a to the hybrid coupler Cp1b. As illustrated in FIG. 9, the terminal T1a is grounded in the state illustrated in FIGS. 9 and 10.

When the transmission signal is supplied from the terminal T2a in the second embodiment, the hybrid coupler Cp1b supplies, to the feeding point P1b, a signal having a phase delayed by 180° from the phase of the transmission signal supplied from the terminal T2a. That is, the transmission signal having a phase of -270 + θ° (+90 + θ°) is supplied to the feeding point P1b. In other words, in the example illustrated in FIGS. 9 and 10, by adjusting the phase shift amount θ, the phase of radio waves in the V polarization direction can be adjusted within the range of 90° to 180°.

When the transmission signal is supplied from the terminal T2a, the hybrid coupler Cp1b supplies, to the feeding point P2b, a signal having a phase delayed by 90° from the phase of the transmission signal supplied from the terminal T2a. That is, the transmission signal having a phase of -180 + θ° (+180 + θ°) is supplied to the feeding point P2b. In other words, in FIGS. 9 and 10, by adjusting the phase shift amount θ, the phase of radio waves in the H polarization direction can be adjusted within the range of 180° to 270°. Since the phase of the signal supplied to the feeding point P2b is advanced relative to the phase of the signal supplied to the feeding point P1b, the radiation electrode Pt1a radiates circularly polarized radio waves rotating rightward (clockwise) toward the radiation direction. As described above, by adjusting feeding positions to which signals advanced in phase by 90 degrees are supplied such that they are symmetric between the antennas 30Ca and 30Cb, the antenna 30Cb outputs radio waves having the same rotational direction as that of the antenna 30Ca in the example illustrated in FIG. 8. That is, in the second embodiment, the array antenna as a whole can output radio waves having a unified rotational direction.

As described above, in the second embodiment, by controlling the switch Sw1 to be in a non-conductive state and controlling the switch Sw2 to be in a conductive state, the phase of radio waves in the V polarization direction in the antenna 30Ca can be adjusted within the range of 0° to 90° by using the phase shifter Ph1 capable of adjusting the phase shift amount θ only within the range of 0° to 90°. Furthermore, in the second embodiment, by controlling the switch Sw1 to be in a conductive state and controlling the switch Sw2 to be in a non-conductive state, the phase of radio waves in the V polarization direction in the antenna 30Ca can be adjusted within the range of 90° to 180° by using the phase shifter Ph1 capable of adjusting the phase shift amount θ only within the range of 0° to 90°. Similarly, in the second embodiment, by controlling the conductive states of the switches Sw1 and Sw2, the phase of radio waves in the H polarization direction can be adjusted within the range of -180° to 0°. As a result, in the second embodiment, the phases of radio waves in the V polarization direction and the H polarization direction can be adjusted over a range exceeding the adjustable range of the phase shift amount θ.

Like in the first embodiment, the path of a transmission signal outputted from the balun Mb1 can be changed by controlling the conductive states of the switches Sw1 and Sw2 that are not disposed on a transmission signal path in the second embodiment. That is, also in the radio frequency module 100A according to the second embodiment, it is possible to switch between signal paths while reducing the occurrence of a switching loss.

### Processing in Signal Processing Circuit

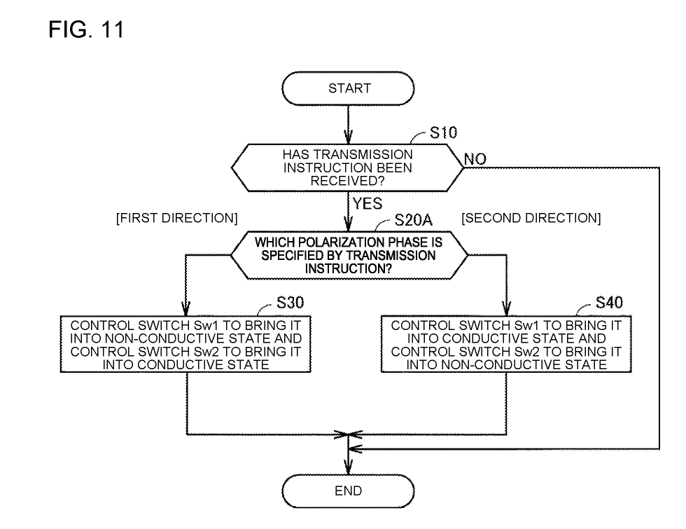

FIG. 11 is a flowchart illustrating a process performed by the signal processing circuit 300 in the second embodiment. The signal processing circuit 300 determines the phase of a radio wave to be supplied to a patch antenna in accordance with the phase of another patch antenna in an array antenna and a specified steering angle of radio waves. For example, as illustrated in FIG. 8, when the phase of radio waves in the V polarization direction is set within the range of 0° to 90° or when the phase of radio waves in the H polarization direction is set within the range of -90° to 0°, the signal processing circuit 300 controls the terminal T1a such that the terminal T1a outputs a phase within the range of 90° to 180°. Furthermore, as illustrated in FIG. 10, when the phase of radio waves in the V polarization direction is set within the range of 90° to 180° or when the phase of radio waves in the H polarization direction is set within the range of 180° to 270°, the signal processing circuit 300 controls the terminal T2a such that the terminal T2a outputs a phase within the range of -90° to 0°. That is, the signal processing circuit 300 receives the designation of at least one of the phase of radio waves in the V polarization direction and the phase of radio waves in the H polarization direction, and switches control between the signal path illustrated in FIG. 8 and the signal path illustrated in FIG. 10. In the following, an example will be described in which the signal processing circuit 300 performs control upon receiving the designation of whether the steering angle of the array antenna is the first direction or the second direction.

Referring to the flowchart illustrated in FIG. 11, when the control unit in the signal processing circuit 300 has received the instruction to transmit a transmission signal (YES in step S10), the control unit determines whether the steering angle of the array antenna specified by the transmission instruction is the first direction or the second direction (step S20A). When the specified steering angle of the array antenna is the first direction, the control unit in the signal processing circuit 300 controls the switch Sw1 to bring it into a non-conductive state and controls the switch Sw2 to bring it into a conductive state (step S30) and returns the process to step S10. That is, the control unit in the signal processing circuit 300 supplies to the terminal T1a a signal having a phase that is greater than or equal to 90° and less than 180°.

When the specified steering angle of the array antenna is the second direction, the control unit in the signal processing circuit 300 controls the switch Sw1 to bring it into a conductive state and controls the switch Sw2 to bring it into a non-conductive state (step S40) and ends the process. That is, the control unit in the signal processing circuit 300 supplies to the terminal T1b a signal having a phase that is greater than or equal to -90° and less than or equal to 0°.

In the example illustrated in FIG. 11, the phase of radio waves in the V polarization direction is a determination target in step S20A. However, the phase of radio waves in the H polarization direction may be a determination target in step S20A. Furthermore, in step S20A in FIG. 11, "the range of greater than 0° and less than or equal to 90°" and "the range of greater than 90° and less than 180°" may be used as determination targets.

### Modification

In the second embodiment, the configuration has been described in which circularly polarized radio waves are outputted using the hybrid coupler Cp1. However, the V polarization and the H polarization may be switched without using the hybrid coupler Cp1.

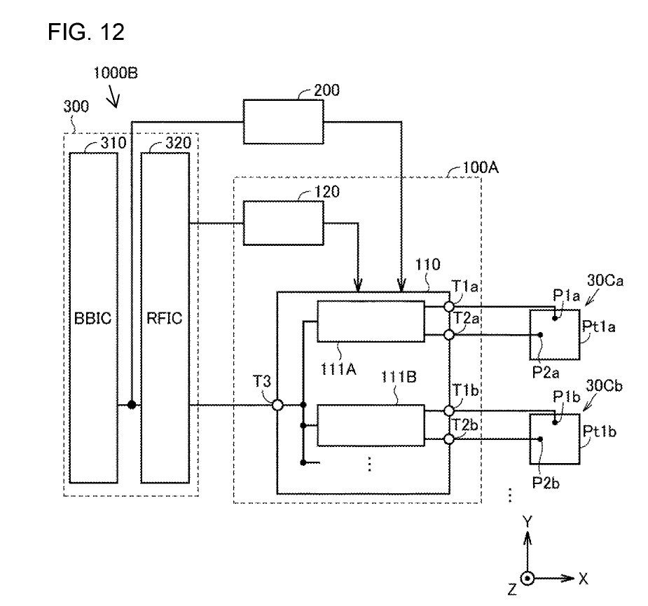

FIG. 12 is a schematic diagram of a communication device 1000B according to a modification. As illustrated in FIG. 12, the communication device 1000B according to the modification has a configuration in which the hybrid couplers Cp1a and Cp1b are removed from the communication device 1000A according to the second embodiment. In the communication device 1000B according to the modification, by controlling the conductive states of the switches Sw1 and Sw2, it is possible to switch between the output of V polarization and the output of H polarization.

It is to be understood that the embodiments disclosed herein are illustrative and non-restrictive in all respects. The scope of the present disclosure is not defined by the above description but by the claims, and all changes that come within the meaning and range of equivalency of the claims are intended to be embraced therein.

What is claimed is:

1. A radio frequency module comprising:
a first output terminal and a second output terminal;
a first balun comprising a main line connected between the first output terminal and the second output terminal, a first sub-line coupled to the main line, and a second sub-line coupled to the main line;
a first amplifier having an output end connected to the first sub-line;
a second amplifier having an output end connected to the second sub-line;
a third amplifier;
a fourth amplifier;
a first line connected between an output end of the third amplifier and the first output terminal;
a second line connected between an output end of the fourth amplifier and the second output terminal;
a first switch connected between the output end of the third amplifier and ground; and
a second switch connected between the output end of the fourth amplifier and ground.

2. The radio frequency module according to claim 1, further comprising:
an input terminal;
a branching circuit configured to branch a signal from the input terminal into a first path and a second path;
a second balun having an unbalanced terminal connected to the first path, and two balanced terminals; and
a third balun having an unbalanced terminal connected to the second path, and two balanced terminals,
wherein a first of the balanced terminals of the second balun is connected to an input end of the first amplifier,
wherein a second of the balanced terminals of the second balun is connected to an input end of the third amplifier,
wherein a first of the balanced terminals of the third balun is connected to an input end of the second amplifier, and
wherein a second one of the balanced terminals of the third balun is connected to an input end of the fourth amplifier.

3. The radio frequency module according to claim 1, wherein a phase difference between a phase of a signal inputted to the first amplifier and a phase of a signal inputted to the second amplifier is 180°.

4. The radio frequency module according to claim 1,
wherein, when a signal is supplied to the first output terminal, the first switch is brought into a non-conductive state, the second switch is brought into a conductive state, and a signal in a first frequency band is inputted to a third input terminal, and
wherein, when a signal is supplied to the second output terminal, the first switch is brought into a conductive state, the second switch is brought into a non-conductive state, and a signal in a second frequency band is inputted to the third input terminal.

5. A communication device comprising:
the radio frequency module according to claim 1;
a first antenna connected to the first output terminal; and
a second antenna connected to the second output terminal.

6. A communication device comprising:
a first amplification circuit;
a second amplification circuit;
a third antenna to which a signal is supplied from the first amplification circuit;
a fourth antenna to which a signal is supplied from the first amplification circuit;
a fifth antenna to which a signal is supplied from the second amplification circuit; and
a sixth antenna to which a signal is supplied from the second amplification circuit,
wherein each of the first amplification circuit and the second amplification circuit comprises:
a first output terminal and a second output terminal,
a first balun comprising a main line connected between the first output terminal and the second output terminal, a first sub-line coupled to the main line, and a second sub-line coupled to the main line,
a first amplifier having an output end connected to the first sub-line,
a second amplifier having an output end connected to the second sub-line,
a third amplifier,
a fourth amplifier,
a first line connected between an output end of the third amplifier and the first output terminal,
a second line connected between an output end of the fourth amplifier and the second output terminal,
a first switch connected between the output end of the third amplifier and ground, and
a second switch connected between the output end of the fourth amplifier and ground.

7. The communication device according to claim 6,
wherein each of the first amplification circuit and the second amplification circuit further comprises:
an input terminal,
a phase shifter configured to adjust a phase of a signal from the input terminal,
a branching circuit configured to branch a signal whose phase has been adjusted by the phase shifter into a first path and a second path,
a third balun having an unbalanced terminal connected to the first path, and two balanced terminals, and
a fourth balun having an unbalanced terminal connected to the second path, and two balanced terminals,
wherein a first of the balanced terminals of the third balun is connected to an input end of the first amplifier,
wherein a second of the balanced terminals of the third balun is connected to an input end of the third amplifier,
wherein a first of the balanced terminals of the fourth balun is connected to an input end of the second amplifier, and
wherein a second of the balanced terminals of the fourth balun is connected to an input end of the fourth amplifier.

8. The communication device according to claim 6, wherein a phase difference between a phase of a signal inputted to the first amplifier and a phase of a signal inputted to the second amplifier is 180°.

9. The communication device according to claim 6, wherein each of the third antenna, the fourth antenna, the fifth antenna, and the sixth antenna is a patch antenna.

10. The communication device according to claim 6, further comprising:
a first hybrid coupler connected between the first amplification circuit and the third antenna;
a second hybrid coupler connected between the first amplification circuit and the fourth antenna;
a third hybrid coupler connected between the second amplification circuit and the fifth antenna; and
a fourth hybrid coupler connected between the second amplification circuit and the sixth antenna,
wherein the first hybrid coupler is configured to supply a first signal to a first feeding point and a second feeding point arranged at positions that are point-symmetric with respect to a center of the third antenna by 90 degrees,
wherein the second hybrid coupler is configured to supply a second signal to a third feeding point and a fourth feeding point arranged at positions that are point-symmetric with respect to a center of the fourth antenna by 90 degrees,
wherein the third hybrid coupler is configured to supply a third signal to a fifth feeding point and a sixth feeding point arranged at positions that are point-symmetric with respect to a center of the fifth antenna by 90 degrees, and
wherein the fourth hybrid coupler is configured to supply a fourth signal to a seventh feeding point and an eighth feeding point arranged at positions that are point-symmetric with respect to a center of the sixth antenna by 90 degrees.

11. The communication device according to claim 6,
wherein, when a signal having a phase that is greater than or equal to 90° and less than 180° is supplied to the first output terminal, the first switch is brought into a non-conductive state and the second switch is brought into a conductive state, and
wherein, when a signal having a phase that is greater than or equal to -90° and less than or equal to 0° is supplied to the second output terminal, the first switch is brought into a conductive state and the second switch is brought into a non-conductive state.

12. The communication device according to claim 5, further comprising a signal processing circuit configured to process a radio frequency signal.
